(19) United States
(12) Patent Application Publication
(10) Pub. No.: US 2026/0303583 A1
(43) Pub. Date: Oct. 1, 2026

(54) AUTHENTICITY VERIFICATION SYSTEM, AUTHENTICITY VERIFICATION METHOD, AND PROGRAM

(71) Applicant: NTT, Inc., Tokyo (JP)

(72) Inventors: Tetsuya OKUDA, Tokyo (JP); Tomohiro INOUE, Tokyo (JP); Kenji UMAKOSHI, Tokyo (JP); Keiichiro KASHIWAGI, Tokyo (JP); Masami IZUMI, Tokyo (JP); Koki MITANI, Tokyo (JP); Daigoro YOKOZEKI, Tokyo (JP)

(21) Appl. No.: 19/490,150

(22) PCT Filed: Jun. 9, 2023
(86) PCT No.: PCT/JP2023/021612

§ 371 Date: Dec. 4, 2025

(51) Int. Cl. H04L 9/40

(52) U.S. Cl. CPC H04L 63/08

(57) ABSTRACT

An authenticity verification system for verifying authenticity of a cluster includes a platform for the cluster that includes a plurality of nodes, and each of the plurality of nodes includes an isolated execution environment. The authenticity verification system includes a user apparatus including first circuitry configured to use a service provided by the cluster, and transmit a request to issue an attestation report to a first node among the plurality of nodes. Each second node of one or mode second nodes among the plurality of nodes includes second circuitry configured to receive the request, and issue the attestation report that includes unique information of the second node, in response to receiving the request.

### TECHNICAL FIELD

The present disclosure relates to an authenticity verification system, an authenticity verification method, and a program.

### BACKGROUND ART

As known techniques of performing calculation while keeping data (also including programs) secret from a cloud provider, there are, for example, confidential computing (Non-patent Literature 1), confidential VM (Non-patent Literature 2), and the like. With these techniques, an isolated execution environment in which computations can be performed can be constructed while maintaining the confidentiality of highly confidential data. For example, services for performing some computational processes on a cloud can be realized while maintaining the confidentiality of the data.

### CITATION LIST

### Non-Patent Literature

Non-patent Literature 1: Microsoft Azure Confidential Computing official webpage https://docs.microsoft.com/ja-jp/azure/confidential-computing/overview
Non-patent Literature 2: Google Confidential VM official webpage https://cloud.google.com/compute/confidential-vm/docs?hl=ja

### SUMMARY OF INVENTION

### Technical Problem

However, when the above-described services are realized on a cluster (for example, a Kubernetes cluster) composed of a plurality of nodes, authenticity of the entire cluster cannot be verified. Therefore, for example, tampering or the like of setting information of a certain node cannot be detected, and safety cannot be guaranteed.

The present disclosure has been made in view of the above circumstances and provides a technique capable of verifying authenticity of the entire cluster that is composed of a plurality of nodes that has an isolated execution environment.

### Solution to Problem

According to an aspect of the present disclosure, an authenticity verification system verifying authenticity of a cluster includes: a platform configured to realize a cluster including a plurality of nodes each including an isolated execution environment; and a user apparatus configured to use a service provided by the cluster. The user apparatus includes a first transmission unit that transmits an issue request of an attestation report to the nodes. The node includes an issuing unit that issues an attestation report including unique information of the node when the issue request is received.

### Effects of Invention

It is possible to provide a technique capable of verifying authenticity of an entire cluster composed of a plurality of nodes that have an isolated execution environment.

### BRIEF DESCRIPTION OF DRAWINGS

FIG. 1 is a diagram illustrating a system configuration example according to one embodiment of the present invention.

FIG. 2 is a diagram illustrating a functional configuration example of a user apparatus.

FIG. 3 is a diagram illustrating a functional configuration example of a master node.

FIG. 4 is a diagram illustrating a functional configuration example of a worker node.

FIG. 5 is a sequence diagram illustrating a flow of an authenticity verifying process in a first embodiment.

FIG. 6 is a sequence diagram illustrating the flow of the authenticity verifying process in a second embodiment.

FIG. 7 is a sequence diagram illustrating a flow of a data distribution process in the first embodiment.

FIG. 8 is a sequence diagram illustrating the flow of the data distribution process in the second embodiment.

FIG. 9 is a sequence diagram illustrating the flow of the data distribution process in a third embodiment.

FIG. 10 is a diagram illustrating a hardware configuration example of a computer.

### DESCRIPTION OF EMBODIMENTS

Hereinafter, one embodiment of the present invention will be described. Embodiments to be described below are merely exemplary, and embodiments to which the present invention is applied are not limited to the following embodiments. Hereinafter, a service that executes some computational processes while maintaining confidentiality of data (also including a program) on an isolated execution environment will be referred to as a “concealment execution service”. Here, the isolated execution environment can be realized by, for example, a technique such as confidential computing (Non-patent Literature 1) or confidential VM (Non-patent Literature 2). The isolated execution environment is called a trusted execution environment (TEE) or the like, and is an environment in which data processing can be executed independently of an existing operating system (OS). The TEE includes, for example, a central processing unit (CPU) such as SEV of AMD (registered trademark), SGX or TDX of Intel (registered trademark), TrustZone (registered trademark) of Arm (registered trademark), and ARM Confidential Compute Architecture. The isolated execution environment may be referred to as, for example, a secret computing mechanism, a concealment computing mechanism, a sandbox, or the like.

### System Configuration Example

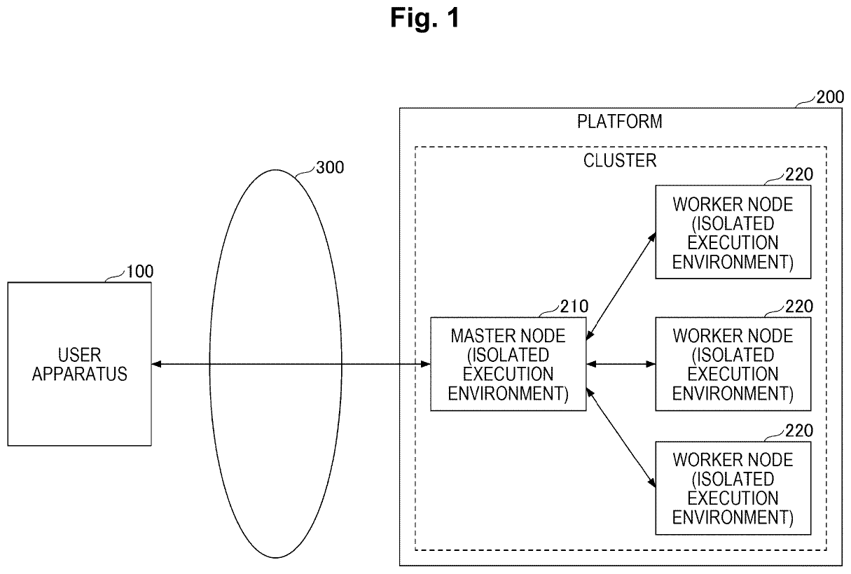

A configuration example of a system in one embodiment is illustrated in FIG. 1. The system illustrated in FIG. 1 includes a user apparatus 100 and a platform 200. The user apparatus 100 and the platform 200 are connected to, for example, a communication network 300 including the Internet or the like.

The user apparatus 100 is any of various apparatuses (for example, a personal computer (PC), a smartphone, a tablet terminal, a wearable apparatus, and the like) used by a user of a concealment execution service. The user of the concealment execution service may be an owner of data (also including a program) used for the concealment execution service or may be a person who acquires or uses only an execution result of the service.

The platform 200 is a physical machine or a physical machine group that realizes a cluster including a plurality of nodes that each include an isolated execution environment. Here, each node included in the cluster is realized by, for example, a virtual machine (VM), a container, a pod, or the like. Hereinafter, as an example, it is assumed that nodes included in a cluster are Kubernetes nodes, and each node is realized with a pod. However, a method of realizing a cluster and each node included in the cluster is not limited thereto.

It is assumed that there are a master node and worker nodes in the nodes included in the cluster. In the example illustrated in FIG. 1, a master node 210 and three worker nodes 220 are illustrated. However, this is an example and there may be no distinction between the master node and the worker nodes.

The master node 210 and each worker node 220 all realize the isolated execution environment and can issue reports called attestation reports provided by the TEE. The attestation report is information with a signature that can include any attribute information. Accordingly, in the present embodiment, a case in which the user verifies authenticity of the cluster using the attestation reports will be described. More specifically, when node-specific information is included in the attestation reports, the user can verify the authenticity of the cluster.

### Premise

Hereinafter, a matter that is a premise of the present embodiment will be described.
Each node generates a key pair of a public key and a private key through any public key cryptosystem when the node is generated (started). This is not necessarily secure between the user apparatus 100 and a node or between nodes, and thus is used for encryption when data is transmitted between the user apparatus 100 and the nodes or between the nodes. Hereinafter, the above keys are referred to as sandbox keys, and are referred to as a sandbox private key and a sandbox public key. For example, a key pair of each worker node 220 may be generated in the master node 210 and the key pair is distributed to each worker node 220.
It is assumed that each node and the user apparatus 100 have a sandbox public key necessary for encryption when data is transmitted to the communication partner.
It is assumed that a policy for access control or the like of data stored in each node is agreed in advance, and each node has a necessary policy (the entire policy or a part of the policy). For example, the master node 210 possesses the entire policy, and each worker node 220 possesses a partial policy for access control or the like of data stored in the worker node 220. Hereinafter, the policy of the master node 210 is referred to as an entire policy, and the policy of each worker node 220 is referred to as a partial policy. The partial policy is allocated (distributed), for example, from the master node 210 to each worker node 220.

### Functional Configuration Example of User Apparatus 100

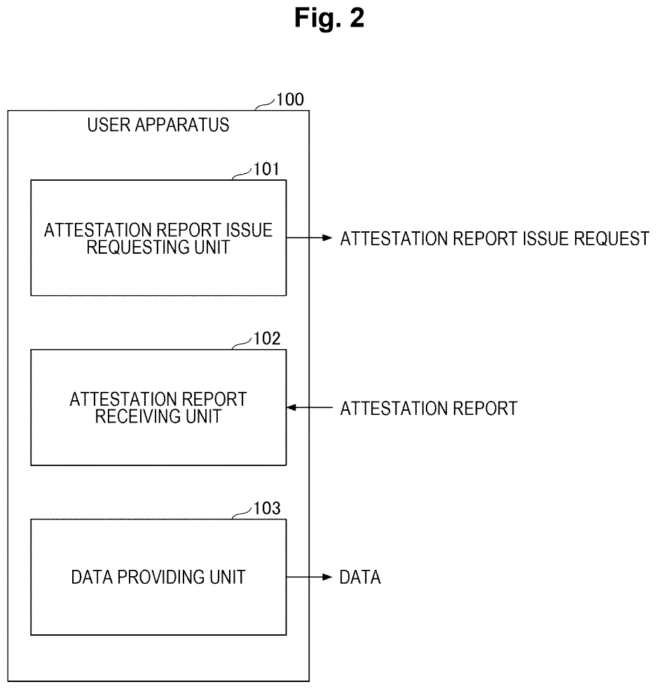

A functional configuration example of the user apparatus 100 is illustrated in FIG. 2. As illustrated in FIG. 2, the user apparatus 100 includes an attestation report issue requesting unit 101, an attestation report receiving unit 102, and a data providing unit 103. These units are realized, for example, through a process in which one or more programs installed in the user apparatus 100 are executed by a processor such as a CPU.

The attestation report issue requesting unit 101 transmits an attestation report issue request to the master node 210 in order to verify authenticity of the cluster.

The attestation report receiving unit 102 receives the attestation report including the node-specific information from the master node 210. At this time, the attestation report receiving unit 102 also receives a result (authenticity verification result) of the master node 210 verifying the node-specific information included in the attestation report of the worker node 220.

The data providing unit 103 transmits data used for the concealment execution service to the master node 210.

At this time, the data providing unit 103 encrypts the data with the sandbox public key of the master node 210, and then transmits the encrypted data to the master node 210.

### Functional Configuration Example of Master Node 210

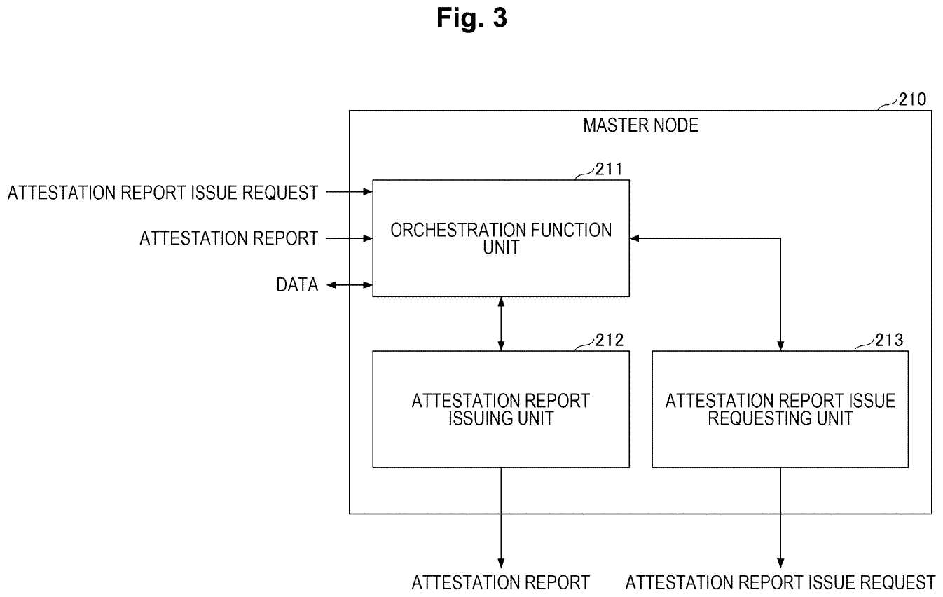

A functional configuration example of the master node 210 is illustrated in FIG. 3. As illustrated in FIG. 3, the master node 210 includes an orchestration function unit 211, an attestation report issuing unit 212, and an attestation report issue requesting unit 213. These units are realized, for example, through a process executed by one or more programs installed in the platform 200 by a program such as a CPU.

The orchestration function unit 211 controls the worker node 220, acquires own node-specific information, verifies the node-specific information included in the attestation report from each worker node 220, and requests other units to perform processes.

The attestation report issuing unit 212 issues the attestation report by the TEE. At this time, the attestation report issuing unit 212 issues an attestation report including the node-specific information of the own (the master node 210).

The attestation report issue requesting unit 213 transmits an attestation report issue request to each worker node 220.

### Functional Configuration Example of Worker Node 220

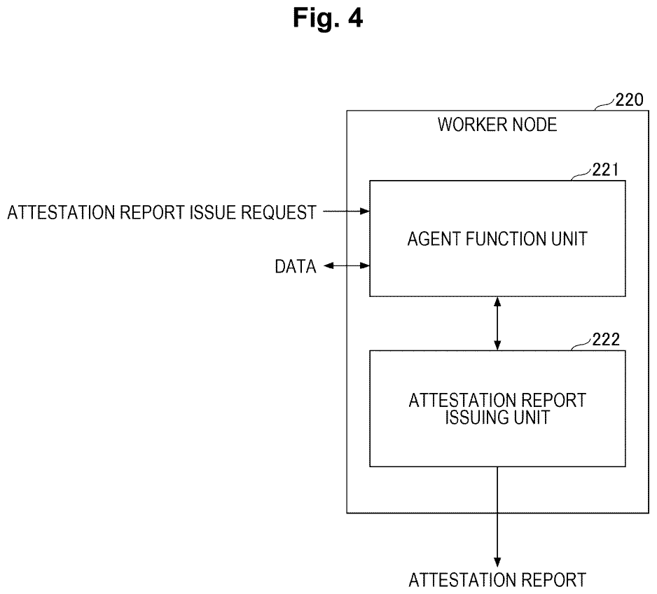

A functional configuration example of the worker node 220 is illustrated in FIG. 4. As illustrated in FIG. 4, the worker node 220 includes an agent function unit 221 and an attestation report issuing unit 222. These units are realized, for example, through a process executed by one or more programs installed in the platform 200 by a program such as a CPU.

The agent function unit 221 acquires own node-specific information and requests other units to perform processes.

The attestation report issuing unit 222 issues the attestation report by the TEE. At this time, the attestation report issuing unit 222 issues an attestation report including the own node-specific information of the own (of the worker node 220).

### Authenticity Verifying Process

Hereinafter, first and second embodiments of the authenticity verifying process in which the user verifies authenticity of the cluster including the master node 210 and each worker node 220 will be described.

### Authenticity Verifying Process (First Embodiment)

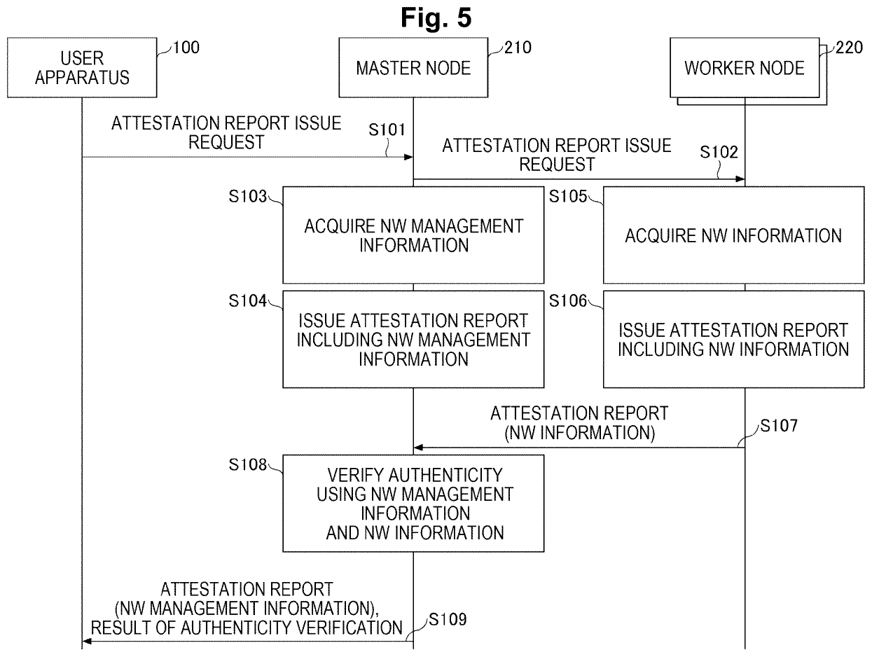

A flow of the authenticity verifying process in the first embodiment will be described with reference to FIG. 5.

The attestation report issue requesting unit 101 of the user apparatus 100 transmits an attestation report issue request to the master node 210 (step S101).

When the orchestration function unit 211 receives the attestation report issue request, the attestation report issue requesting unit 213 of the master node 210 transmits an attestation report issue request to each worker node 220 (step S102).

The orchestration function unit 211 of the master node 210 acquires the NW management information as the own node-specific information (step S103). Here, the NW management information is information regarding the network of the entire cluster and includes, for example, an Internet Protocol (IP) address, a port number, FW setting, a task name, and an image name of each worker node 220. The NW management information can be acquired by, for example, a function such as a command provided by Kubernetes.

The attestation report issuing unit 212 of the master node 210 issues an attestation report including the NW management information acquired in step S103 (step S104).

The agent function unit 221 of each worker node 220 acquires NW information as own node-specific information (step S105). Here, the NW information is information regarding the network of the worker node 220 and includes, for example, an IP address, a port number, FW setting, a task name, an image name of the worker node 220. The NW information can be acquired by, for example, a function such as a command provided by Kubernetes.

The attestation report issuing unit 222 of each worker node 220 issues an attestation report including the NW information acquired in the foregoing step S105 (step S106).

The attestation report issuing unit 222 of each worker node 220 transmits the attestation report issued in the foregoing step S106 to the master node 210 (step S107).

The orchestration function unit 211 of the master node 210 verifies authenticity of each worker node 220 using the NW management information acquired in the foregoing step S103 and the NW information included in the attestation report received from each worker node 220 (step S108). That is, the orchestration function unit 211 verifies that the NW information of each worker node 220 is correct (that is, not falsified) using the NW management information as the correct answer.

The attestation report issuing unit 212 of the master node 210 transmits the attestation report issued in the foregoing step S104 and the result of the authenticity verification in the foregoing step S108 to the user apparatus 100 (step S109).

As described above, the user can confirm the authenticity of each worker node 220 from the result of the authenticity verification. The authenticity of the entire cluster can be confirmed using the NW management information included in the attestation report.

### Authenticity Verifying Process (Second Embodiment)

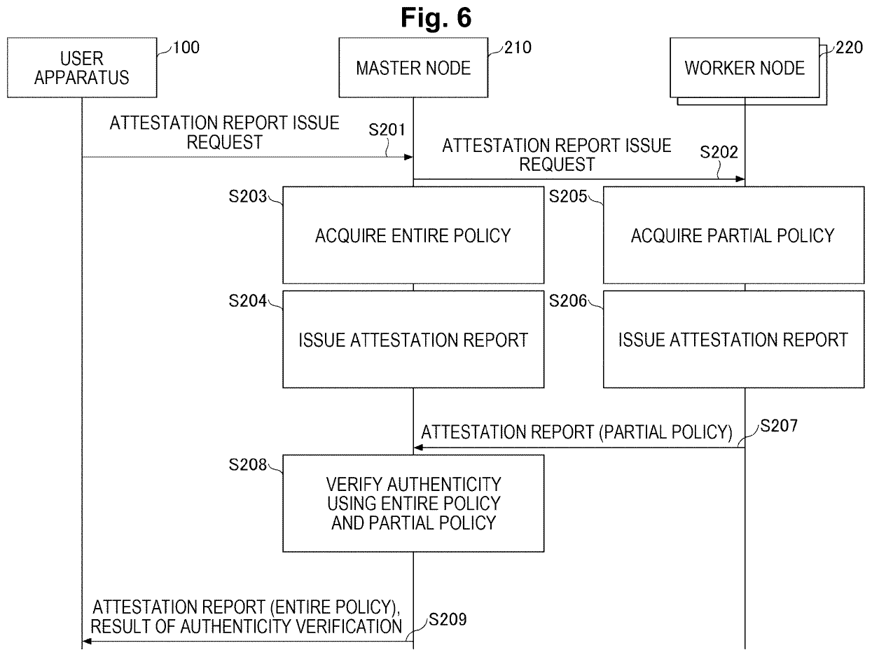

A flow of the authenticity verifying process according to the second embodiment will be described with reference to FIG. 6.

The attestation report issue requesting unit 101 of the user apparatus 100 transmits an attestation report issue request to the master node 210 (step S201).

When the attestation report issue request is received by the orchestration function unit 211, the attestation report issue requesting unit 213 of the master node 210 transmits an attestation report issue request to each worker node 220 (step S202).

The orchestration function unit 211 of the master node 210 acquires the entire policy as the own node-specific information (step S203). In the entire policy, for example, data stored by each worker node 220, information regarding access control for the data, and the like are defined. The entire policy is, for example, information defined in Open Digital Rights Language (ODRL) or the like that is a policy expression language. Here, this is an example, and the entire policy may be defined in any language.

The attestation report issuing unit 212 of the master node 210 issues an attestation report including the entire policy acquired in the foregoing step S203 (step S204).

The agent function unit 221 of each worker node 220 acquires a partial policy as the own node-specific information (step S205). In the partial policy, for example, data stored by the worker node 220, information regarding access control for the data, and the like are defined. The partial policy is partial information of the entire policy.

The attestation report issuing unit 222 of each worker node 220 issues an attestation report including the partial policy acquired in the foregoing step S205 (step S206).

The attestation report issuing unit 222 of each worker node 220 transmits the attestation report issued in the foregoing step S206 to the master node 210 (step S207).

The orchestration function unit 211 of the master node 210 verifies the authenticity of each worker node 220 using the entire policy acquired in the foregoing step S203 and the partial policy included in the attestation report received from each worker node 220 (step S208). That is, the orchestration function unit 211 verifies that the partial policy of each worker node 220 is correct (that is, not falsified) using the entire policy as the correct answer.

The attestation report issuing unit 212 of the master node 210 transmits the attestation report issued in the foregoing step S204 and the result of the authenticity verification in the foregoing step S208 to the user apparatus 100 (step S209).

As described above, the user can confirm the authenticity of each worker node 220 from the result of the authenticity verification. The authenticity of the entire cluster can be confirmed using the NW management information included in the attestation report.

### Data Distribution Process

Hereinafter, first to third embodiments of a data distribution process of transmitting data used for a concealment execution service from the user apparatus 100 to the master node 210 and of further transmitting (distributing) the data to the worker node 220 using the data will be described.

### Data Distribution Process (First Embodiment)

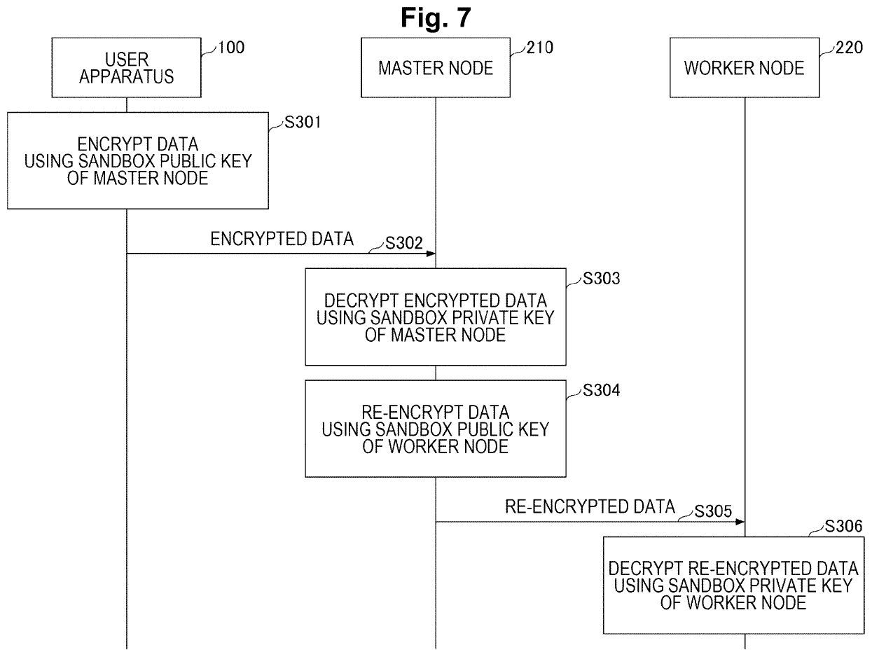

A flow of the data distribution process according to the first embodiment will be described with reference to FIG. 7.

The data providing unit 103 of the user apparatus 100 encrypts transmission target data using the sandbox public key of the master node 210 (step S301). Hereinafter, the data encrypted in this step is referred to as encrypted data.

The data providing unit 103 of the user apparatus 100 transmits the encrypted data obtained in the foregoing step S301 to the master node 210 (step S302).

When the encrypted data is received, the orchestration function unit 211 of the master node 210 decrypts the encrypted data using an own sandbox private key (step S303).

The orchestration function unit 211 of the master node 210 encrypts the data decrypted in the foregoing step S303 using the sandbox public key of the worker node 220 (step S304). Hereinafter, the data encrypted in this step is referred to as re-encrypted data.

The orchestration function unit 211 of the master node 210 transmits the re-encrypted data obtained in the foregoing step S304 to the worker node 220 (step S305).

When the re-encrypted data is received, the agent function unit 221 of the worker node 220 decrypts the re-encrypted data using an own sandbox private key (step S306). Accordingly, the worker node 220 can store the data and use the data in the concealment execution service.

### Data Distribution Process (Second Embodiment)

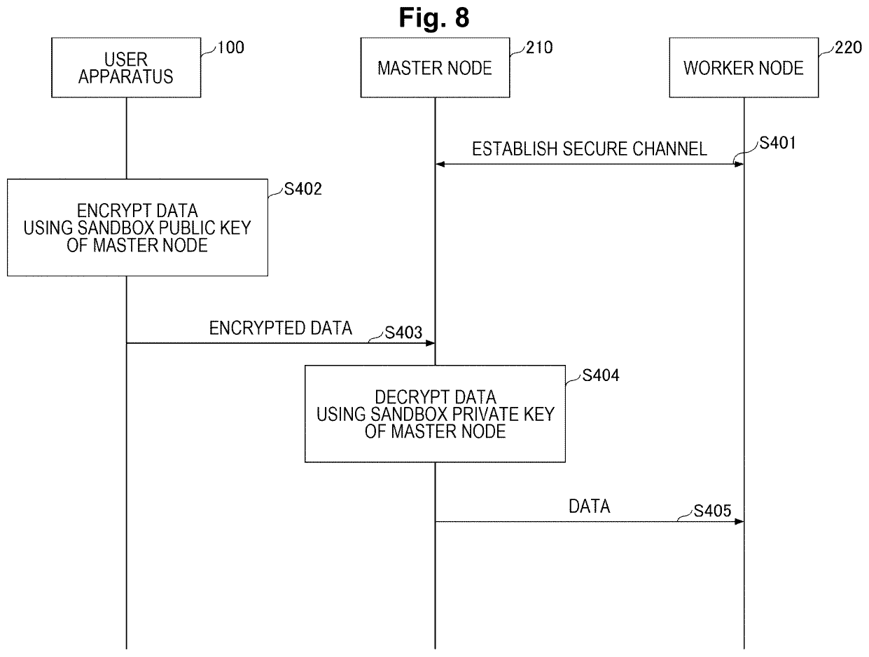

A flow of the data distribution process according to the second embodiment will be described with reference to FIG. 8.

The orchestration function unit 211 of the master node 210 and the agent function unit 221 of the worker node 220 establish a secure channel (step S401). For example, transport layer security (TLS), IPsec, VXLAN (VXLAN over IPsec), or the like may be established as the secure channel. At this time, when authentication or mutual authentication is necessary, authenticity verification of the attestation report may be substituted.

For example, in the case of the establishment of TLS as a secure channel, when the master node 210 serves as a server, the worker node 220 serves as a client, and the master node 210 authenticates the worker node 220, authenticity verification of the attestation report in step S107 of FIG. 5 or step S207 of FIG. 6 may be regarded as client authentication. On the other hand, when the worker node 220 authenticates the master node 210, a server certificate (or a hash value of the server certificate) is used as usual. In this case, an attestation report including the server certificate (or the hash value of the server certificate) may be transmitted from the master node 210 to the worker node 220. By including the server certificate (or the hash value of the server certificate) in the attestation report, the worker node 220 can verify that the server certificate is a certificate from the valid master node 210.

The data providing unit 103 of the user apparatus 100 encrypts transmission target data using the sandbox public key of the master node 210 (step S402). Hereinafter, the data encrypted in this step is referred to as encrypted data.

The data providing unit 103 of the user apparatus 100 transmits the encrypted data obtained in the foregoing step S402 to the master node 210 (step S403).

When the encrypted data is received, the orchestration function unit 211 of the master node 210 decrypts the encrypted data using an own sandbox private key (step S404).

The orchestration function unit 211 of the master node 210 transmits the data decrypted in the foregoing step S404 to the worker node 220 using the secure channel established in the foregoing step S401 (step S405). Accordingly, the worker node 220 can store the data and use the data in the concealment execution service.

In the data distribution process according to the second embodiment, since data is transmitted from the master node 210 to the worker node 220 using the secure channel, it is not necessary for the master node 210 to hold the sandbox public key of the worker node 220. Therefore, for example, as compared with the data distribution process according to the first embodiment, it is possible to reduce complexity of key management when the worker node 220 is frequently started and deleted.

### Data Distribution Process (Third Embodiment)

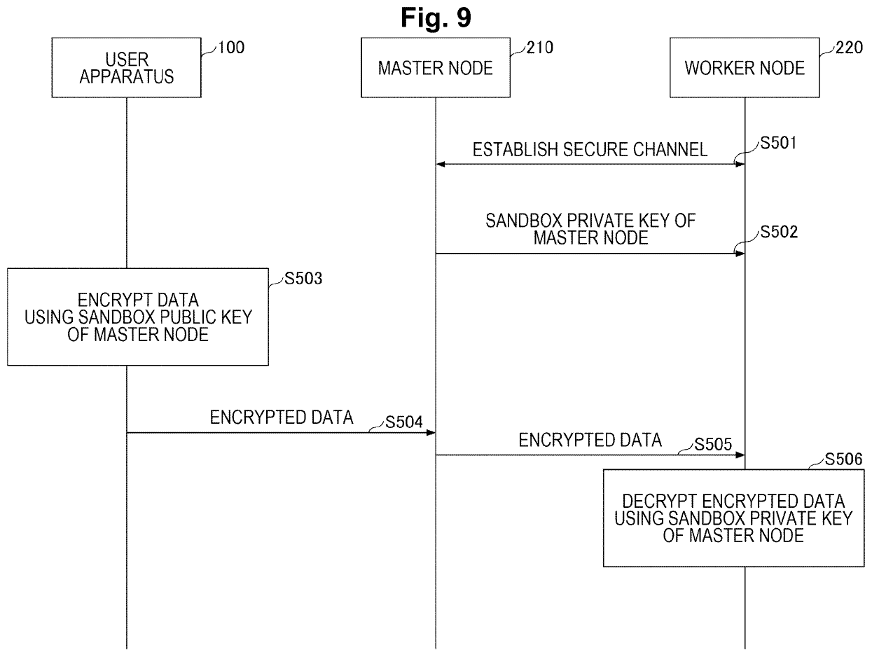

A flow of the data distribution process according to the third embodiment will be described with reference to FIG. 9.

The orchestration function unit 211 of the master node 210 and the agent function unit 221 of the worker node 220 establish a secure channel as in step S401 of FIG. 8 (step S501).

The orchestration function unit 211 of the master node 210 transmits the own sandbox private key to the worker node 220 using the secure channel established in the foregoing step S501 (step S502).

The data providing unit 103 of the user apparatus 100 encrypts transmission target data using the sandbox public key of the master node 210 (step S503). Hereinafter, the data encrypted in this step is referred to as encrypted data.

The data providing unit 103 of the user apparatus 100 transmits encrypted data obtained in the foregoing step S503 to the master node 210 (step S504).

When the encrypted data is received, the orchestration function unit 211 of the master node 210 transmits the encrypted data to the worker node 220 (step S505).

When the encrypted data is received, the agent function unit 221 of the worker node 220 decrypts the encrypted data using the sandbox private key of the master node 210 (step S506). Accordingly, the worker node 220 can store the data and use the data in the concealment execution service.

In the data distribution process according to Example 3, since the sandbox private key of the master node 210 is transmitted from the master node 210 to the worker node 220 using the secure channel, it is not necessary for the master node 210 to hold the sandbox public key of the worker node 220. Therefore, for example, as compared with the data distribution process according to the first embodiment, it is possible to reduce complexity of key management when the worker node 220 is frequently started and deleted.

### Hardware Configuration Example

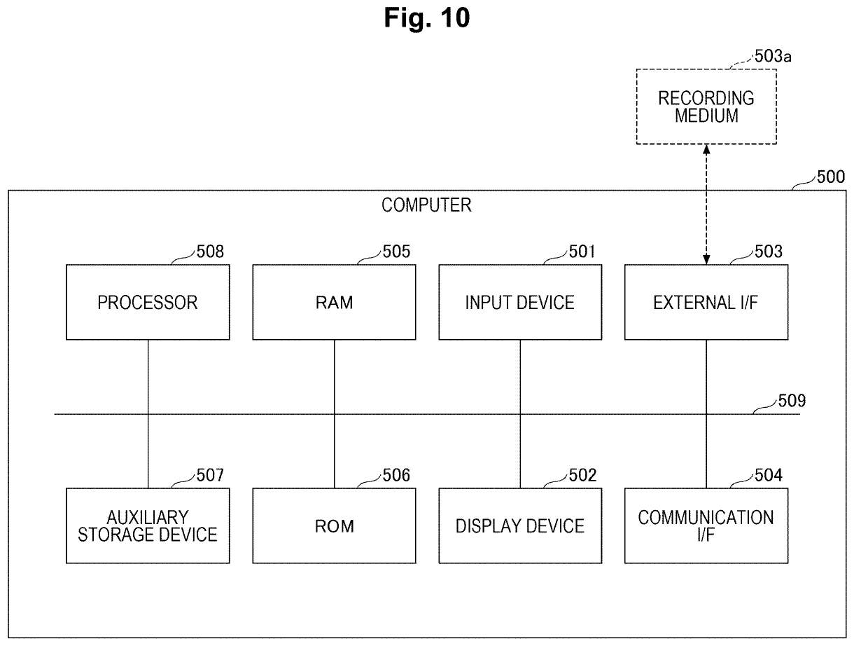

The physical machine that realizes the user apparatus 100 and the platform 200 can be realized by, for example, a hardware configuration of the computer 500 illustrated in FIG. 10. The computer 500 illustrated in FIG. 10 includes an input device 501, a display device 502, an external I/F 503, a communication I/F 504, a random access memory (RAM) 505, a read only memory (ROM) 506, an auxiliary storage device 507, and a processor 508. Each of the hardware is communicably connected via a bus 509.

The input device 501 is, for example, a keyboard, a mouse, a touch panel, a physical button, or the like. The display device 502 is, for example, a display, a display panel, or the like. The computer 500 may not include, for example, at least one of the input device 501 and the display device 502.

The external I/F 503 is an interface with an external apparatus such as a recording medium 503a. Examples of the recording medium 503a include a compact disc (CD), a digital versatile disk (DVD), a secure digital memory card (SD memory card), and a universal serial bus (USB) memory card.

The communication I/F 504 is an interface for connecting the computer 500 to a communication network. The RAM 505 is a volatile semiconductor memory (storage device) that temporarily stores programs and data. The ROM 506 is a nonvolatile semiconductor memory (storage device) capable of storing programs and data even when the power is turned off. The auxiliary storage device 507 is, for example, a storage device such as a hard disk drive (HDD), a solid state drive (SSD), or a flash memory. The processor 508 is, for example, any of various arithmetic devices such as a CPU.

The hardware configuration of the computer 500 illustrated in FIG. 10 is exemplary, and the present invention is not limited thereto. For example, the computer 500 may include a plurality of auxiliary storage devices 507 and a plurality of processors 508, may not include some of the illustrated hardware, or may include various types of hardware other than the illustrated hardware.

### Modifications

Hereinafter, modifications of the foregoing embodiments will be described.

### Modification 1

By combining the authenticity verifying process according to the first embodiment and the authenticity verifying process according to the second embodiment, the authenticity of the cluster including the plurality of nodes may be verified with both the information regarding the network (the NW management information and the NW information) and the policy (the entire policy and the partial policy).

### Modification 2

In the authenticity verifying process according to the first embodiment, the NW management information is used as the user-specific information of the master node 210, and the NW information is used as the user-specific information of the worker node 220. In addition to this, various types of unique information held by the OS on the platform 200, an information processing apparatus (for example, a physical machine such as a PC or a server) that realizes the platform 200, or the like may be used. For example, a snapshot or the like may be used as the user-specific information. When a snapshot is used as the user-specific information, for example, the authenticity is verified by the snapshot included in each worker node 220 by using the snapshot of the master node 210 as a correct answer. Here, as the snapshot, for example, it is conceivable to use a snapshot of a CPU, a snapshot of a storage, or the like. As described in the foregoing Modification 1, authenticity may be verified further using a policy.

A specific example of the snapshot of the CPU is a snapshot of register information or the like of the CPU. Specific examples of the snapshot of the storage include a snapshot of device information of a network card or a storage, and a snapshot of network information (iSCSI, FiberChannel, NAS, or the like) of a storage connected to a network. Furthermore, specific examples of the unique information held by the OS or the information processing apparatus include a build number of the OS, a serial number of the information processing apparatus, a binary of firmware (for example, the OVMF or the like), and a hash value of an initial RAM disk (for example, initrd or initramfs).

### Modification 3

In the authenticity verifying process according to the second embodiment, when the master node 210 verifies the partial policy of each worker node 220 and the authenticity is accordingly verified, the master node 210 may hold the sandbox public key of the worker node 220 having the partial policy in association with the partial policy. Similarly, when the user verifies the entire policy to verify the authenticity, the user apparatus 100 may hold the sandbox public key of the master node 210 in association with the entire policy. Accordingly, the master node 210 can hold the partial policy of each worker node 220 of which the authenticity is confirmed and the sandbox public key in association. Similarly, the user apparatus 100 can hold the entire policy of the master node 210 included in the cluster of which the authenticity has been confirmed and the sandbox public key in association. Therefore, it is possible to use the sandbox public key of the node, whose authenticity has been confirmed through the data distribution process.

### Modification 4

In the foregoing embodiment, the master node and the worker nodes are distinguished from each other. However, the master node and the worker nodes may not be distinguished from each other. In this case, the user apparatus 100 transmits an attestation report issue request to each node, and each node transmits an attestation report including the own node-specific information to the user apparatus 100. Accordingly, the user can verify the authenticity of the node from the node-specific information included in the attestation report from each node.

### Modification 5

When communication can be performed between the worker nodes 220, authenticity verification may be performed between the worker nodes 220. For example, an attestation report issue request may be transmitted from a certain worker node 220 to another worker node 220, and the other worker node 220 may transmit an attestation report including the own node-specific information to the certain worker node 220. Accordingly, the certain worker node 220 can verify the authenticity of the other worker node 220.

Here, each worker node 220 may acquire the partial policy and the public key of another worker node 220 to which the worker node itself transmits the attestation report issue request from the master node 210 by the attestation report. At this time, each worker node 220 may give a request for the partial policy and the public key of the other worker nodes 220 to the master node 210 using, for example, a name or the like that uniquely identifies the other worker node 220.

Each worker node 220 may obtain the partial policy and the public key of another worker node 220 to which the worker node 220 transmits the attestation report issue request from the master node 210 every time, or the partial policy and the public key may be allocated from the master node 210 in advance.

### Modification 6

In the data distribution process (first to third embodiments) of the foregoing embodiments, the case in which the data providing unit 103 of the user apparatus 100 transmits the data (the encrypted data) to the master node 210 has been described, but the data providing unit 103 may transmit, for example, the encrypted data obtained with the public key of the worker node 220 to the worker node 220.

Not only in a case in which the encrypted data is transmitted from the data providing unit 103 of the user apparatus 100, but each node may also acquire data (encrypted data) from the data providing unit 103.

### Modification 7

In the foregoing embodiment, each worker node 220 possesses the partial policy for access control or the like of data stored therein, but the present invention is not limited thereto. For example, each worker node 220 may possess the entire policy and key pairs of all the worker nodes 220. In this case, the entire policy and the key pairs of all the worker nodes 220 are allocated from the master node 210 to each worker node 220.

### Conclusion

As described above, according to the system including the platform 200 that realizes a cluster including a plurality of nodes each including the user apparatus 100 and the isolated execution environment according to the present embodiment, a user can verify the authenticity (that is, the setting information or the like of the cluster is not falsified) of the cluster. Therefore, when the concealment execution service provided by the cluster is used, the user can use the concealment execution service after confirming the safety.

The present invention is not limited to the above embodiment(s) specifically disclosed, and various modifications and changes, combinations with known techniques, and the like can be made without departing from the scope of the claims.

### REFERENCE SIGNS LIST

100 User apparatus
101 Attestation report issue requesting unit
102 Attestation report receiving unit
103 Data providing unit
200 Platform
210 Master node
211 Orchestration function unit
212 Attestation report issuing unit
213 Attestation report issue requesting unit
220 Worker node
221 Agent function unit
222 Attestation report issuing unit
300 Communication network
500 Computer
501 Input device
502 Display device
503 External I/F
503a Recording medium
504 Communication I/F
505 RAM
506 ROM
507 Auxiliary storage device
508 Processor
509 Bus

1. An authenticity verification system for verifying authenticity of a cluster, comprising:
a platform for the cluster that includes a plurality of nodes, each of the plurality of nodes including an isolated execution environment; and
a user apparatus including first circuitry configured to:
use a service provided by the cluster, and
transmit request to issue an attestation report to a first node among the plurality of nodes,
wherein each second node of one or mode second nodes among the plurality of nodes includes second circuitry configured to:
receive the request, and
issue the attestation report that includes unique information of the second node, in response to receiving the request.

2. The authenticity verification system according to claim 1,
wherein the first node is a master node, and each second node is a worker node,
wherein the first circuitry of the user apparatus is configured to transmit the request to issue the attestation report to the master node, and
wherein the master node includes third circuitry configured to:
receive the request to issue the attestation report,
transmit the request to one or more worker nodes
verify authenticity of the unique information included in the attestation report that is received from each of the one or more worker nodes, by using the unique information of the master node, and
transmit the attestation report that includes unique information of the master node and an authenticity verification result to the user apparatus.

3. The authenticity verification system according to claim 2, wherein the third circuitry of the master node is configured to verify whether tampering of the unique information included in the attestation report received from each of the one or more worker nodes is performed, by using the unique information of the master node as a correct answer.

4. The authenticity verification system according to claim 1, wherein the unique information of each second node includes at least one of information relating to a network, a policy relating to access control of data that is held by the second node, unique information of an operating system on the platform, or unique information of an information processing apparatus that implements the platform.

5. The authenticity verification system according to claim 1,
wherein the first circuitry of the user apparatus is configured to transmit encrypted data encrypted with a public key of the first node to the first node, and
wherein the first node includes third circuitry configured to:
acquire target data obtained by decrypting the encrypted data with a private key of the first node, and
transmit the target data to a given second node among the one or more second nodes via a secure channel that is established in advance by regarding the attestation report that is received from the given second node as authentication of the given second node.

6. The authenticity verification system according to claim 1,
wherein the first circuitry of the user apparatus is configured to transmit encrypted data encrypted with a public key of the first node to the first node, and
wherein the first node includes third circuitry configured to:
transmit, to a given second node among the one or more second nodes, a private key of the first node with which the encrypted data is decrypted, via a secure channel that is established in advance by regarding the attestation report that is received from the given second node as authentication of the given second node, and
transmit the encrypted data to the given second node.

7. An authenticity verification method in an authenticity verification system for verifying authenticity of a cluster that includes:
a platform for the cluster that includes a plurality of nodes, each of the plurality of nodes including an isolated execution environment, and
a user apparatus that uses a service provided by the cluster, the authenticity verification method comprising:
transmitting, by the user apparatus, a request to issue an attestation report to a first node among the plurality of nodes; and
receiving, by each second node of one or more second nodes of the plurality of nodes, the request; and
issuing, by each second node, the attestation report that includes unique information of the second node, in response to receiving the request.

8. A non-transitory computer readable storage medium storing a program configured to cause the authenticity verification system of claim 7 to perform the authenticity verification method of claim 7.
